(19) United States
(12) Patent Application Publication
(10) Pub. No.: US 2004/0216377 A1
(43) Pub. Date: Nov. 4, 2004

(54) Self Watering Plant Container

(76) Inventors: Franklin D Cox, Santa Fe, NM (US); Hazel L Cox, Santa Fe, NM (US)

Correspondence Address: Franklin D Cox, Hazel L Cox, P. O. Box 22384, 35 Cibola Circle, Santa Fe, NM, 87505

(21) Appl. No.: 10/708,961

(22) Filed: Apr. 2, 2004

Related U.S. Application Data
(60) Provisional application No. 60/463,105, filed on Apr. 14, 2003.

(51) Int. Cl. A01G 25/00

(52) U.S. Cl. 47/81

(57) ABSTRACT

The invention includes a plant container partitioned with a divider. The divider acts as a platform to support the soil and plant and has a wick and a fill tube inserted into it and small holes to allow rain or extra water to drain into the reservoir. The soil goes in the top partition and the bottom partition contains the water reservoir. There is a wick containing packed peat moss that wicks the water from the reservoir to the soil in the top partition. This wicking action allows the plant to maintain for a week or more without additional watering.

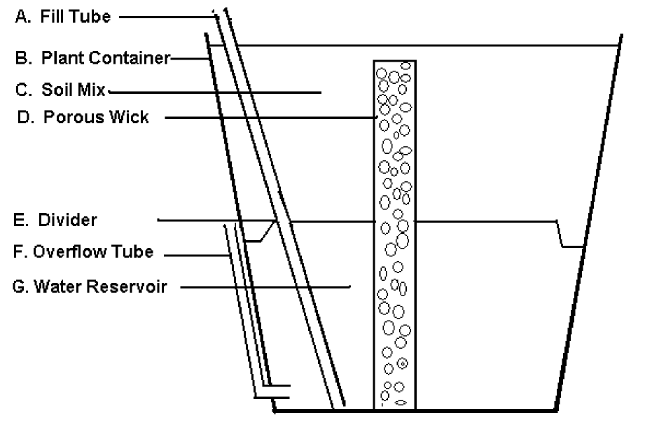

### DETAILED DESCRIPTION

A: The fill tube is constructed from ¾ inch to 1 inch copper or plastic pipe cut to length.

B: Soil is a recommended mix of enriched soil and peat moss. Should be 50/50 mix of soil and peat moss as the peat moss keeps the moisture evenly distributed in the soil mix.

C: Divider is constructed of plastic with holes for wick, fill tube, and drainage holes to allow rain or excess water to enter reservoir.

D: Overflow is an elbow made of clear or translucent plastic with a clear plastic extension that allows the observation of water level when reservoir is nearly full. If reservoir is overfilled from adding water or rain the excess water will simply run out of overflow. This prevents flooding of the plant roots and allows soil drainage of excess water.

E: Water reservoir will hold various amounts of water depending on the size of the container. This reservoir will hold enough water for 1 to 3 weeks with out additional watering.

F. Wick is a porous plastic tube hard packed with peat moss. Peat moss is an organic material that has natural wicking properties. The wicking properties are enhanced by hard packing of the peat moss.

1. As the plant grows it will put roots down into the reservoir and grow into the wick. This allows the plant to have plenty of water. Plants will self regulate their water intake naturally in this environment. Components including the wick will vary in diameter, length, and thickness depending on the size of container. The drawing shows the preferred embodiment of the invention. Although the invention has been described in detail with particular reference to these preferred embodiments, other embodiments can achieve the same results. Variations and modifications of the present invention will be obvious to those skilled in the art and it is intended to cover all such modifications and equivalents.
